(19) United States
(12) Patent Application Publication
(10) Pub. No.: US 2025/0192446 A1
(43) Pub. Date: Jun. 12, 2025

(54) Array antenna of the type comprising a plurality of planar radiating elements fed in series

(71) Applicants: THALES, Meudon (FR); Centre national de la recherche scientifique, PARIS (FR); Institut Polytechnique de Bordeaux, TALENCE (FR); UNIVERSITÉ DE BORDEAUX, BORDEAUX (FR)

(72) Inventors: Anthony GHIOTTO, BEGLES (FR); Stefan VARAULT, TRAPPES (FR); Yoan VEYRAC, MERIGNAC (FR); Valentin LOURENCO MARTINS, MERIGNAC CEDEX (FR)

(21) Appl. No.: 18/970,869

(22) Filed: Dec. 5, 2024

(30) Foreign Application Priority Data
Dec. 12, 2023 (FR) 2313998

(51) Int. Cl. H01Q 21/06; H01Q 21/00

(52) U.S. Cl. CPC H01Q 21/065; H01Q 21/0006

(57) ABSTRACT

An array antenna including a plurality of radiating elements fed in series and arranged along a vertical axis, operates under horizontal polarization, by connecting two successive radiating elements along the vertical axis by a pair of differential lines, each line having a length equal to the wavelength guided in the line, one end of a line being connected to a horizontal edge of a radiating element and the other end of the line being connected to the horizontal edge facing the other radiating element, a single radiating element being provided with at least one horizontal excitation point, positioned outside the vertical axis, preferably in proximity to a vertical edge of the single radiating element.

### REFERENCE TO RELATED APPLICATION

This application is a U.S. non-provisional application claiming the benefit of French Patent Application No. 23 13998 filed on Dec. 12, 2023, the contents of which are incorporated herein by reference in their entirety.

### TECHNICAL FIELD OF THE INVENTION

The present invention relates to array antennas of the type which has a plurality of planar radiating elements (or “patch” antennas) fed in series—SFPA (“Series-Fed Patch Antenna”).

### BACKGROUND OF THE INVENTION

FIG. 1 shows an antenna according to the prior art.

An antenna 101 results from the vertical series connection of a plurality of planar radiating elements 102ᵢ, of length Lᵢ and width Wᵢ, making it possible to generate a vertically polarized wave, i.e., parallel to the axis V along which the different planar radiating elements of the antenna are arranged.

The antenna geometry relies directly on the TM10 resonance mode of each planar radiating element.

In the resonance mode, as illustrated on the central element 102₃, the electric field between the ground plane and the metal plane which are constituents of the lower face and the upper face, respectively, of the planar radiating element is anti-symmetrical with respect to the horizontal axis H, which is the axis orthogonal to the vertical axis V. On the upper and lower horizontal edges, the electric field is homogeneous, i.e., is either positive or negative, and substantially constant. On the other hand, on the left- and right-hand edges, the electric potential varies and changes sign at the horizontal axis H.

Such a potential structure serves to generate a wave the electric field E of which is oriented along the vertical axis V, i.e., a vertically polarized wave.

Under such conditions, in order to propagate the resonance mode TM10 from one element to the neighbor thereof, a microstrip feed line 105ᵢ is used, which electrically connects the center of the horizontal edge, e.g., the upper edge, of a radiating element 102ᵢ and the center of the lower horizontal edge of the neighbor radiating element 102ᵢ₊₁. Moreover, the single line has a length equal to λg/2 (with λg the wavelength guided in the line) in order to invert the electric field between the two ends of the line, i.e., the field on the upper horizontal edge, with respect to the field on the lower horizontal edge, and thereby make resonate in phase the two radiating elements thereby connected.

In array antenna 101, the feed is provided by a single excitation point P_{V} located on the axis V, but distant from the axis H.

For the entire antenna to resonate at the desired frequency, all radiating elements must also resonate at the same frequency. Consequently, the length Lᵢ of each element is substantially identical from one element to another and is close to λg/2 (the electric field of the lower and upper edges of the same element being in phase opposition). Strictly speaking, as each element does not have the same neighbors, different couplings are established, which shifts the resonance frequency. The shift may be compensated by adjusting the length Lᵢ of each element.

In polarimetric radar applications, such as Synthetic-Aperture Radar (SAR), antennas with orthogonal polarizations are required.

In the case of linear V/H polarization, to provide the symmetry of the radiation patterns and good integrability, it is necessary that antennas operating in horizontal polarization and same operating in vertical polarization have the same physical footprint.

However, at present, there is no SFPA antenna operating with a polarization oriented along the axis orthogonal to the axis of the array of planar radiating elements, i.e., under horizontal polarization when the radiating elements are vertically aligned.

### SUMMARY OF THE INVENTION

Therefore, the goal of the present invention is to propose an SFPA antenna under horizontal polarization.

To this end, the subject matter of the invention is an array antenna of the type including a plurality of planar radiating elements fed in series, the planar radiating elements being arranged along a so-called vertical axis, a so-called horizontal axis, orthogonal to the vertical axis, intersects the latter at a central point, characterized in that, for operation under horizontal polarization, two successive planar radiating elements along the vertical axis are electrically connected to each other by a pair of differential lines, each line of the pair of differential lines having a length equal to an integer of wavelength guided along the line, an end of a line of the pair of differential lines being connected to a horizontal edge of a planar radiating element and the other end of the line being connected to the horizontal edge facing the other planar radiating element, the guided wavelength corresponding to the resonance frequency of the array antenna, a single planar radiating element of the plurality of planar radiating elements being provided with at least one horizontal excitation point, for an operation under horizontal polarization, the horizontal excitation point being outside the vertical axis, preferably in proximity to a vertical edge of the planar radiating element.

According to other advantageous aspects of the invention, the antenna includes one or a plurality of the following features, taken individually or according to all technically possible combinations:
the different planar radiating elements have a rectangular shape and a substantially equal dimension along the horizontal axis and, preferably, a dimension along the vertical axis which decreases as a function of a distance from the planar radiating element to the central point;
the array antenna is symmetrical about the vertical axis and symmetrical about the horizontal axis;
the single planar radiating element of the plurality of planar radiating elements is provided with two horizontal excitation points, for differential excitation of the array antenna;
for an operation under vertical polarization, simultaneously or alternatively to an operation under horizontal polarization, two successive planar radiating elements along the vertical axis are furthermore electrically connected to each other by a single line, the single line having a length equal to half a wavelength guided in the single line, one end of the single line being connected to a horizontal edge of a planar radiating element and the other end of the single line being connected to the horizontal edge facing the other planar radiating element, and a single planar radiating element of the plurality of planar radiating elements is provided with at least one vertical excitation point, for an operation under vertical polarization, the vertical excitation point being outside the horizontal axis, preferably in proximity to a horizontal edge of the planar radiating element;
the single planar radiating element of the plurality of planar radiating elements is provided with two vertical excitation points, for a differential excitation of the array antenna;
a line is a microstrip line or a coplanar line or a stripline;
each planar radiating element is a patch antenna;
the array antenna includes M groups of planar radiating elements, each group including a plurality of N planar radiating elements arranged along the vertical axis, the different elements of a group being arranged along the vertical axis and the different groups being arranged along the horizontal axis, two successive radiating elements along the vertical axis of a group being coupled by a pair of differential lines of a guided wavelength, and a single radiating element of a group being coupled to a single radiating element of another group by a single half wavelength guided along the horizontal direction; and
the antenna includes M groups of planar radiating elements, each group including a plurality of N planar radiating elements arranged along the vertical axis, the different elements of a group being arranged along the vertical axis and the different groups being arranged along the horizontal axis, two successive radiating elements along the vertical axis of a single group being coupled by a pair of differential lines of a guided wavelength, and each radiating element of a group being coupled to a neighbor radiating element of another group by a single line of half wavelength guided along the horizontal direction.

### BRIEF DESCRIPTION OF THE DRAWINGS

The invention will be clearer upon reading the following description, given only as an example, but not limited to, and making reference to the drawings wherein:

FIG. 1 is an embodiment of an array antenna according to the prior art resulting from the vertical series of a plurality of planar radiating elements operating under vertical polarization;

FIG. 2 is an embodiment of an array antenna according to the invention resulting from the vertical series connection of a plurality of planar radiating elements operating under horizontal polarization;

FIG. 3 is a graph of the gain as a function of frequency for the antenna shown in FIG. 2;

FIG. 4 shows the radiation patterns, in azimuth section and in elevation section, of the antennas shown in FIGS. 1 and 2, respectively;

FIG. 5 is a first variant of embodiment of the antenna shown in FIG. 2;

FIG. 6 is a second variant of embodiment of the antenna shown in FIG. 2; and

FIG. 7 is a second embodiment of the antenna according to the invention, for obtaining a dual horizontal and vertical polarization.

### DETAILED DESCRIPTION OF EMBODIMENTS

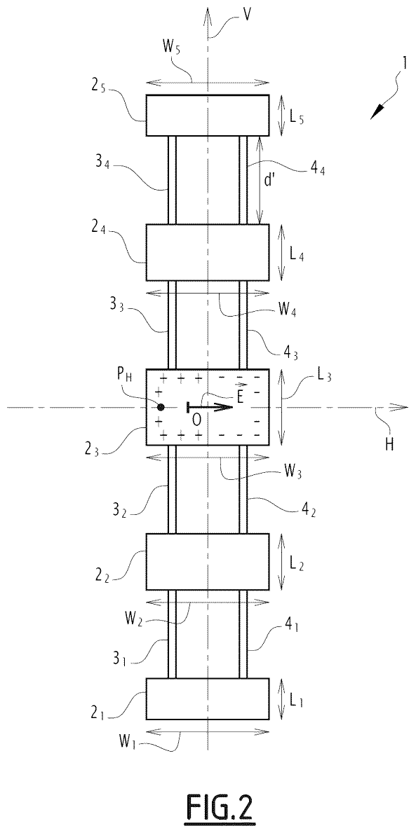

FIG. 2 represents an embodiment of an antenna according to the invention.

An antenna 1 results from the series connection along a vertical axis V of a plurality of N planar radiating elements 2ᵢ (or elementary patch antennas) for an operation under horizontal polarization. N is an integer greater than or equal to two. Each element is indexed by an integer i between 1 and N.

Antenna 1 includes, e.g., five elements: a second lower element 2₁, a first lower element 2₂, a central element 2₃, a first upper element 2₄ and a second upper element 2₅.

The different planar radiating elements 2ᵢ are arranged along the vertical axis V. The axis orthogonal to the vertical axis V is the horizontal axis H. Same intersects the vertical axis V at the origin point O.

Antenna 1 is symmetrical with respect to vertical axis V.

Antenna 1 is symmetrical with respect to horizontal axis H.

The center O is thus a center of symmetry of antenna 1.

In the embodiment shown in FIG. 2 where the array antenna includes an odd number of elements, the center of the central element 2₃ coincides with the origin point O.

Each element 2ᵢ has a width Wᵢ along axis H and a length Lᵢ along axis V.

In the embodiment shown in FIG. 2, the elements have a substantially identical width. The length Lᵢ decreases when moving away from center O of antenna 1.

Two successive planar radiating elements 2ᵢ and 2ᵢ₊₁ along axis V are electrically connected to each other by a pair of differential feed lines, e.g., microstrip lines 3ᵢ and 4ᵢ.

More precisely, the upper horizontal edge of element 2ᵢ and the lower horizontal edge of adjacent element 2ᵢ₊₁, situated immediately above element 2ᵢ, are connected, on the one hand, by a line 3ᵢ to the left of the vertical axis V and, on the other hand, by a line 4ᵢ to the right of the vertical axis V.

In this way, a differential coupling is established between two successive planar radiating elements of the array antenna.

The array antenna is excited by a suitable electrical signal, which is applied to the metal plane of one of the elements, preferably the central element 2₃, at an excitation point P_{H}.

The point P_{H} is situated on horizontal axis H, but outside vertical axis V, preferably close to an edge, e.g., the left vertical edge, of the central element 2₃ in order to provide good linear polarization.

Application of the electric excitation signal to the point P_{H} serves to make element 2₃ resonate according to the mode TM01.

The electric field in the planar radiating element 2₃ is represented schematically in FIG. 2 by “+” and “−” signs. The electric field is, e.g., negative to the left and positive to the right of axis V over half a period of the excitation signal and vice versa over the following half period. The electric field is distributed symmetrically with respect to axis H, but anti-symmetrically with respect to axis V.

Thereby, excitation of the radiating element according to the TM01 mode serves to generate a horizontally polarized wave, i.e., the electric field E of which is oriented along horizontal axis H.

In order to electrically associate two neighboring planar radiating elements, 2ᵢ and 2ᵢ₊₁, and make them resonate in phase, lines 3ᵢ and 4ᵢ have a length d′ equal to the guided wavelength λg (or to an integer multiple of the guided wavelength λg) so as to add in a phase shift of 360° between the electric field at one end of the lines and the electric field at the other end of lines 3ᵢ and 4ᵢ.

The wavelength λg is determined at the resonance frequency F₀ of array antenna 1.

In this way, the same distribution of the electric field is obtained in each of elements 2i.

In other words, the radiating elements are excited in phase according to mode TM01.

The performance of antenna 1 is adapted in the same way as for antenna 101 according to the prior art.

The adjustment of widths Wᵢ makes it possible to set the resonance frequency, and the adjustment of lengths Lᵢ makes it possible to give the aperture of the antenna a variable width by setting the gain of each radiating element and thereby creating a weighting for minimizing the side lobes.

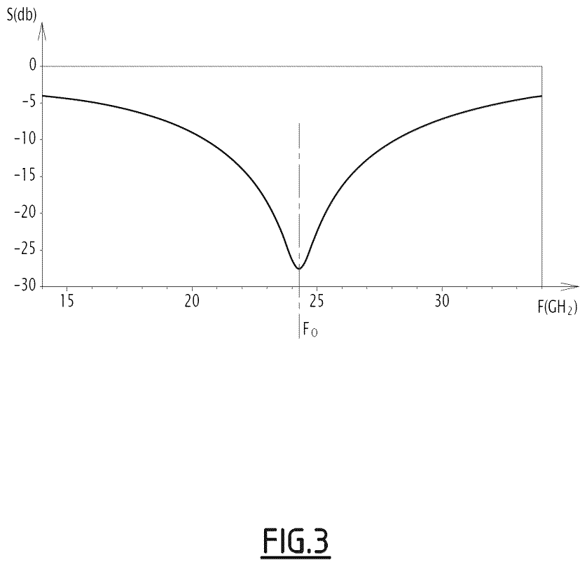

Antenna 1 has a parameter S having the shape shown in FIG. 3. Antenna 1 may be a variably narrow band around resonance frequency F₀, depending on the thickness and permittivity of the substrate, on the values of the lengths Lᵢ chosen and on the location of feed point P_{H}.

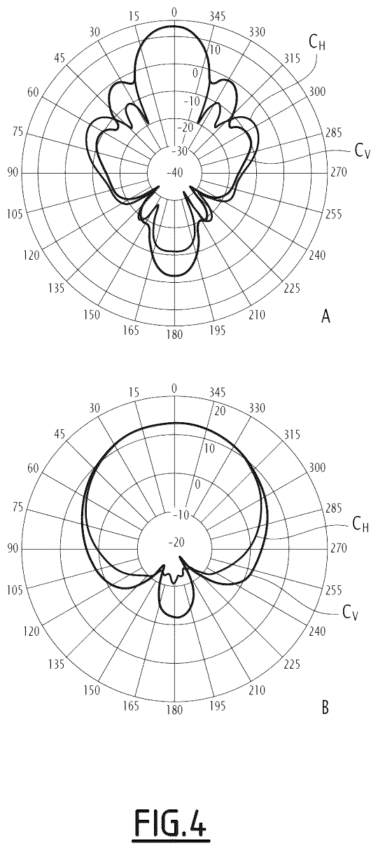

FIG. 4 makes it possible to compare the radiation patterns of antennas 1 and 101 at the same resonance frequency F₀ equal to 24 GHz.

The radiation patterns, C_{V} for antenna 101 and C_{H} for antenna 1, are very close, both in elevation (plane containing axis V and the normal to the plane of the radiating elements) (FIG. 4A) and in azimuth (plane containing the axis H and the normal to the plane of the radiating elements) (FIG. 4B). Such result is the result sought and is perfectly coherent since the topologies are finally very close.

A very important datum when doing polarimetry is the cross-polarization, i.e., the energy radiated in the polarization orthogonal to the desired polarization. The lower the value, the more efficient the antenna is for a polarimetry application. The topology of antenna 1 makes it possible to achieve cross-polarization values on the order of −25 dB, without special adjustments.

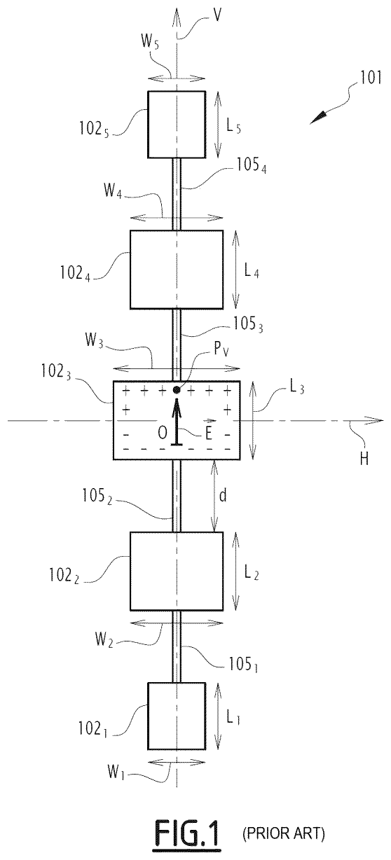

In a variant, instead of being rectilinear, the interconnection lines between planar radiating elements may form one or a plurality of meanders. By folding the lines in this way, the spacing between the elements may be reduced, while maintaining the requirement on the length of the lines. More particularly, as a result, it is possible to impart the array antenna according to the invention with a physical footprint identical to that of the antenna shown in FIG. 1.

In a variant, the microstrip lines may be replaced by coplanar lines or else by striplines.

In the embodiment shown in FIG. 2, the feed is provided by a single excitation point P_{H}.

More generally, it is possible to produce the feed by considering all known types of feed for patch antennas. In particular, it is possible to provide the feed by two vias, arranged along axis H, symmetrically with respect to center O of the element to be excited, and supplied in phase opposition (differential assembly). It is also possible to provide the feed by coupling through one or a plurality of slots arranged in a ground plane of the radiating element, vertically in line with the excitation point on the metallic plane forming the upper surface of the radiating element.

The advantage of using two excitation points for horizontal polarization operation and/or two excitation points for vertical polarization operation, makes it quite easy to gain 3 dB of radiated power in emission, while improving quality of the isolation with cross-polarization and symmetry of the diagram.

In the embodiment shown in FIG. 2, the antenna forms a 1×N matrix.

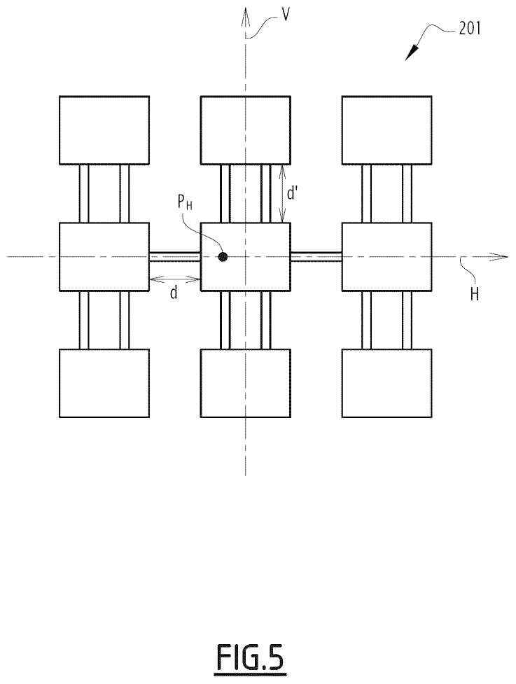

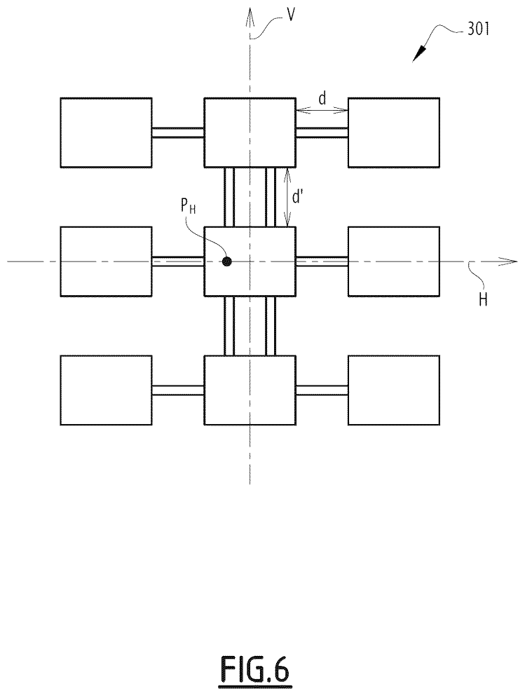

As illustrated in FIGS. 5 and 6, it is possible to produce array antennas forming a matrix of M lines and N columns operating under horizontal polarization, by combining a coupling by a single line along the horizontal direction and by a pair of differential lines along the vertical direction.

For example, in the first variant of FIG. 5, an array antenna 201 forms a 3×3 matrix resulting from the association along axis H of three column array antennas identical to each other and to the antenna shown in FIG. 2. Such association is made by connecting the central element of each column array antenna by a simple link of a guided half wavelength.

For example, in the second variant of FIG. 6, an antenna 301 forms a 3×3 matrix resulting from the association along axis V of three row array antennas identical to each other and to the antenna shown in FIG. 1 (by means of a rotation of 90°). Such association is made by connecting the central element of each line array antenna by a pair of differential lines of a guided wavelength.

In the two variants, the positioning of excitation point P_{H} makes it possible to propagate the mode TM01 from the central element to the peripheral elements of the array antenna.

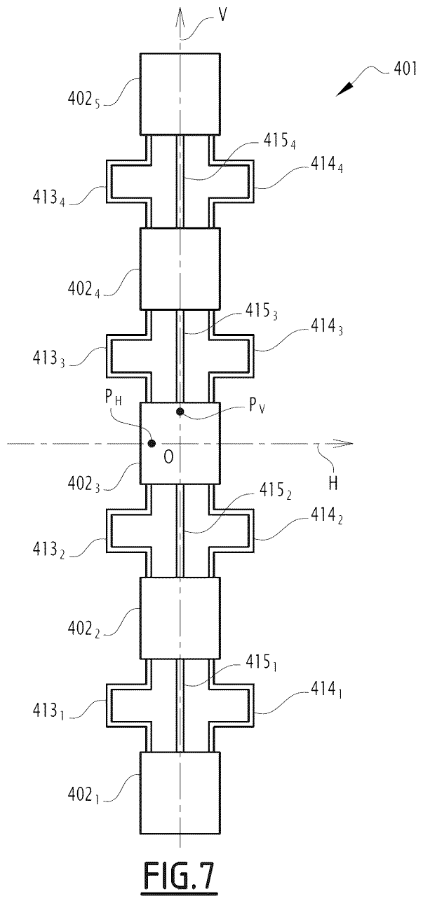

FIG. 7 shows a second embodiment of the antenna according to the invention that operates under horizontal polarization and/or under vertical polarization.

An antenna 401 combines the SFPA topology under horizontal polarization and the SFPA topology under vertical polarization, thereby making possible a dual polarization operation.

For this purpose, each radiating element 402ᵢ has a substantially square shape so as to be able to be excited according to the TM10 mode and the TM01 mode.

The central element 402₃ is provided with two feed points, a point P_{H} for exciting the horizontal polarization, and a point P_{V} for exciting the vertical polarization. It is then possible to choose the desired polarization by suitably feeding each of the ports.

As explained hereinabove, two adjacent radiating elements are connected by three lines:
A single line 415ᵢ of length λg/2 for polarization along axis V; and
Two differential lines, 413ᵢ and 414ᵢ in length for polarization along axis H.

The lines that connect two radiating elements being of different length, one or other of the tracks no longer being rectilinear, but curvilinear (curved, bent, meandering, etc.)

To minimize the problems of coupling the signal from the horizontal polarization by common mode to the vertical polarization, the spacing and impedance of the differential lines can be varied.

Moreover, by exciting the two ports simultaneously with a selected phase shift, it is possible to have agility under polarization so as to generate circular polarizations or polarizations inclined with respect to axes H and V.

It is also possible to have the vertical configuration V and the horizontal configuration H which operate in two different frequency bands. For this purpose, it suffices to play with the vertical and horizontal dimensions of the unitary antenna elements.

The fields of application of the invention are radars, jammers, radios and data links, as well as multifunction systems using electronic scanning array antennas.

Most particularly, the present invention finds an application for radars with large numbers of unit antennas, where it may be advantageous to couple the radiating elements directly to each other by feed lines, and only have to excite the array antenna by a single element. As a result, it possible to reduce the number of transmission/reception modules for generating the electrical signal in transmission, or for acquiring the electrical signal in reception.

The present invention is also compatible with conventional bandwidth broadening techniques, such as stacked patch antennas, as presented in the reference A. A. Serra, P. Nepa, G. Manara, G. Tribellini and S. Cioci, “A Wide-Band Dual-Polarized Stacked Patch Antenna,” in IEEE Antennas and Wireless Propagation Letters, Vol. 6, pp. 141-143, 2007, doi: 10.1109/LAWP.2007.893101.

1. An array antenna of the type comprising a plurality of planar radiating elements fed in series, the planar radiating elements being arranged along a vertical axis, a horizontal axis orthogonal to the vertical axis intersecting the vertical axis at a central point, wherein, for operation under horizontal polarization, two successive planar radiating elements along the vertical axis are electrically connected to each other by a pair of differential lines, each line of the pair of differential lines having a length equal to an integer multiple of a guided wavelength in the line, a first end of each line of the pair of differential lines being connected to a first horizontal edge of a first planar radiating element and a second end of the line being connected to a second horizontal edge of a second planar radiating element, the first and second horizontal edges facing each other, the guided wavelength corresponding to a resonance frequency of the array antenna, a single planar radiating element of said plurality of planar radiating elements being provided with at least one horizontal excitation point, for operation under horizontal polarization, the at least one horizontal excitation point being outside the vertical axis.

2. The array antenna according to claim 1, wherein the at least one horizontal excitation point is in proximity to a vertical edge of said single planar radiating element.

3. The array antenna according to claim 1, wherein each planar radiating element of said plurality of planar radiating elements has a rectangular shape, a dimension thereof along the horizontal axis being constant and a dimension thereof along the vertical axis decreasing as a function of a distance from the central point.

4. The array antenna according to claim 1, wherein the array antenna is symmetrical about the vertical axis and symmetrical about the horizontal axis.

5. The array antenna according to claim 1, wherein said single planar radiating element is provided with two horizontal excitation points, for a differential excitation of the array antenna.

6. The array antenna according to claim 1, in which, for operating in vertical polarization, simultaneously or alternatively to operating in horizontal polarization, two successive planar radiating elements along the vertical axis are furthermore electrically connected to each other by a single line, the single line having a length equal to half a guided wavelength in the single line, a first end of the single line being connected to the first horizontal edge of the first planar radiating element and a second end of the single line being connected to the second horizontal edge of the second planar radiating element, the first and second horizontal edges facing each other and the single planar radiating element of said plurality of planar radiating elements is provided with at least one vertical excitation point, for an operation under vertical polarization, the vertical excitation point being outside the horizontal axis.

7. The array antenna according to claim 6, wherein the vertical excitation point is in proximity to a horizontal edge of the single planar radiating element.

8. The array antenna according to claim 6, wherein the single planar radiating element of said plurality of planar radiating elements is provided with two vertical excitation points, for a differential excitation of the array antenna.

9. The array antenna according to claim 1, wherein a line is a microstrip line or a coplanar line or a stripline.

10. The array antenna according to claim 1, wherein each planar radiating element is a patch antenna.

11. The array antenna according to claim 1, wherein the array antenna includes M groups of planar radiating elements, each group including a plurality of N planar radiating elements arranged along the vertical axis, the planar radiating elements of each group being arranged along the vertical axis and the M groups being arranged along the horizontal axis, two successive radiating elements along the vertical axis of a same group being coupled by a pair of differential lines with a length of one guided wavelength, and for a pair of two successive groups along the vertical axis, only one radiating element of a first group of the pair being coupled to only one radiating element of a second group of the pair by a single line with a length of one half guided wavelength, along the horizontal direction.

12. The array antenna according to claim 1, wherein the antenna includes M groups of planar radiating elements, each group including a plurality of N planar radiating elements arranged along the vertical axis, the planar radiating elements of each group being arranged along the vertical axis and the M groups being arranged along the horizontal axis, two successive radiating elements along the vertical axis of the same group being coupled by a pair of differential lines with a length of one guided wavelength, and each radiating element of a group being coupled to a neighboring radiating element of another group by a single line with a length of one half guided wavelength, along the horizontal direction.
